(19) United States
(12) Patent Application Publication
(10) Pub. No.: US 2012/0054091 A1
(43) Pub. Date: Mar. 1, 2012

(54) METHOD AND SYSTEM FOR SELECTING QUALIFICATION FORMS FOR FINANCIAL SERVICES AND FINANCIAL PRODUCTS

(76) Inventors: Marianne Painter, Waxhaw, NC (US); Kevin Wojcikewych, Matthews, NC (US); Brad Gebert, Charlotte, NC (US); Douglas Lebda, Charlotte, NC (US); Richard Stiegler, Waxhaw, NC (US)

(21) Appl. No.: 13/292,243

(22) Filed: Nov. 9, 2011

Related U.S. Application Data
(63) Continuation of application No. 10/828,649, filed on Apr. 21, 2004, now abandoned.
Application No. 10/828,649 is a continuation-in-part of application No. 10/409,647, filed on Apr. 8, 2003, now abandoned.
(60) Provisional application No. 60/506,557, filed on Sep. 26, 2003.

(51) Int. Cl. G06Q 40/02

(52) U.S. Cl. 705/38

(57) ABSTRACT

According to a first aspect of the invention, a method for coordinating an electronic credit qualification form between an Internet user and a plurality of lending institutions via the Internet is provided. This method of the first aspect of the invention involves a special loan processing computer that automatically applies a first filter to the data. According to a second aspect of the invention, a second filter can be applied to qualification form data that remains after the first filter. This second filter can by customized by a financial service provider who can also control the process of applying the second filter in a semi-manual manner.

### CROSS REFERENCE TO RELATED APPLICATION

This application claims priority to, and is a continuation of, U.S. Non-Provisional application Ser. No. 10/828,649, filed Apr. 21, 2011 which claims priority to, and is a continuation-in-part of, U.S. Non-Provisional application Ser. No. 10/409,647, filed Apr. 8, 2003, and claims priority to U.S. Provisional Application Ser. No. 60/506,557, filed on Sep. 26, 2003. Both the provisional and non-provisional applications are hereby incorporated by reference.

### BACKGROUND OF THE INVENTION

1. The Field of the Invention

The invention relates to a process for coordinating financial services with a computer over the Internet. The Internet, a vast collection of computers world wide, is a relatively new medium for both personal and commercial entities to transact business.

2. The Prior Art

Various methods are known for presenting web pages over the Internet. For example, information about the Internet and web browsers can be found in U.S. Pat. No. 5,701,451 to Rogers et al., which is incorporated herein by reference. Rogers et al., details how requests of a web browser are processed. The Rogers invention speeds up the process for receiving requests from web browser users and retrieving the required information. U.S. Pat. No. 5,535,407 To Yanagawa et al., details a customer data processing system which is used to assist credit card purchases made in stores. The Yanagawa invention simplifies the way in which credit card purchases are verified at the time of checkout. U.S. Pat. No. 4,346,442 to Musmanno details a securities brokerage-cash management system. The Musmanno invention maintains customer brokerage accounts, charge cards and checking accounts and calculates available credit for purchases of securities.

3. Problems with the Prior Art and Conventional Technology

Until now, there has been no way to apply for credit from a multitude of financial service providers without physically going to or calling each financial service provider and filling out an application or financial service provider qualification form (QF). This process was tedious and time consuming. All forms required substantially the same information: name, address, occupation, debt, amount of loan, etc. To address this problem of repetitive and identical forms for financial services, one exemplary aspect of the present invention can combine the vast resources and speed of the Internet with additional knowledge of various financial service provider's selection criteria to create a simple mechanism whereby an Internet user can apply for financial services offered from a multitude of financial service providers.

While the first aspect of the present invention can address the repetitive information needed in qualification forms (QFs) described above, a second exemplary aspect of the present invention can also solve the problem of identifying additional qualification forms for financial service providers that may have been eliminated by very stringent selection criteria used by financial service providers during the exemplary automated process described above.

In other words, an inefficiency could exist when borderline or marginally acceptable qualification forms (QFs) are eliminated during the automated process because of overly stringent or very conservative financial service provider selection criteria. A particular qualification form that does not meet very conservative financial service provider criteria may, in fact, reflect a viable customer or business lead that may provide a profitable experience for the financial service provider.

Another possible inefficiency with an automated selection process exists for those qualification forms during the automated process that did not match selection criteria of a requisite number of different financial service providers. Qualification forms that do not match selection criteria of a requisite threshold number of financial service providers are usually maintained in a database until the qualification forms at some point match the financial service provider selection criteria for the requisite threshold number of financial service providers. Those qualification forms that are maintained in the database and that have not received requisite threshold number of offers usually do not provide any profit for the owner of the automated selection process and database.

Accordingly, there is a further need in the art for maximizing the use of qualification forms that may not match very conservative selection criteria of an automated selection process but may be in fact be qualification forms (QFs) of consumers who may constitute an acceptable amount of business risk for a particular financial service provider. There is also need in the art for providing business contacts or business leads to financial service providers based on qualification forms that can be selected with a manually adjustable filter.

### SUMMARY OF THE INVENTION

To overcome these limitations, it is therefore an object of the present invention to provide a fast, convenient process to apply for credit from a large number of lending institutions. In accordance with the present invention, needless repetitive applications or credit qualification forms can be eliminated.

It is a further object of the present invention to provide a universal credit qualification form (QF) over the Internet and to allow the Internet user to submit a single credit application to a plurality of lending institutions who then make offers to the customer via the Internet.

To achieve these and other objects of the invention and according to a first exemplary inventive aspect, there is provided a method and apparatus for coordinating an electronic credit application between an Internet user and a plurality of lending institutions via the Internet. The method can comprise the steps of displaying a plurality of documents to an Internet user, receiving a plurality of credit data sent from the Internet user; matching an electronic credit application to a first filter comprising a plurality of selection criteria; transmitting the credit data to a plurality of lending institutions via one of four methods; and responding to the Internet user via the Internet.

The documents sent to the Internet user can include a series of questions pertaining to their desired loan, followed by the appropriate type of loan application. The various types of loan applications can include, but are not limited to, first and second mortgages, car loans, student loans, personal loans, and credit card applications. Other types of credit applications may exist without departing from the spirit of the invention. Upon completion of the application, the invention can match a unique, first filter to the credit data entered by the Internet user.

The first filter can be made up of a plurality of selection criteria in which a specific lending institution has given to the inventor. The first filter can be customizable by the specific lending institution in real time and unique to each lending institution. Once the application has been filtered with the first filter, it can be sent to a list of lending institutions that match with the credit application. These lending institutions then reply as to whether the application has been accepted or rejected.

The information can be sent in many different ways. For example, the information can be sent in an Active File Transfer system (AFTS), via e-mail, through a secured webpage or through a Common Gateway Interface (CGI). In addition, since much of the information relayed between the network of computers is private information, it can be encrypted before it is sent from one computer to another.

According to a second exemplary aspect of the present invention, a method and system for identifying qualification forms (QFs) in a database comprising qualification forms that have passed through a first filter of an automated process can be provided. With this method and system of the second exemplary aspect, a financial service provider can set up a second filter to process qualification forms that have not matched a requisite threshold of a number different financial service providers.

The method and system according to this exemplary aspect can allow a financial service provider to customize a second filter so that a financial service provider can search qualification forms (QF) using fields of the qualification forms (QFs) that are of interest or meet a threshold (usually lower than thresholds in the first filter) to a particular financial service provider. The method and system can allow a financial service provider to search and to select those qualification forms that are of interest based on customized searches conducted by a financial service provider. In turn, the method and system can allow the owner of a qualification form database to sell additional qualification forms that do not meet or match stringent or very conservative selection criteria of an automated process.

According to the second exemplary inventive aspect, the database of qualification forms that did not meet the stringent or very conservative automated selection criteria can track which qualification forms that have been purchased during the second filtering process by a particular financial service provider. According to another exemplary aspect, the QF database can monitor and restrict its access by financial service providers such that each qualification form eligible for purchase is only available to one financial service provider. With such a restriction, financial service providers will not be permitted to purchase the same qualification forms and thereby increase their chance of a successful business transaction with the consumer identified in the qualification form. According to a further exemplary aspect, the QF database could permit the purchase of each qualification form by more than one financial service provider.

While parts of this specification addressing the first exemplary aspect of the present invention may refer to lending institutions, borrowers, and loan qualification forms, those skilled in the art recognize that the invention is not limited to the financial services of coordinating loans between borrowers and lenders. The present invention can cover a wide range of financial services and financial service products between a consumer and a financial service provider. Some financial services and financial service products covered by the first and second exemplary aspects of the invention include, but are not limited to, small business loans, commercial mortgages, first mortgages, second mortgages, car loans, student loans, personal loans, credit cards, bank accounts, stock brokerage accounts, retirement accounts, and any other type of financial product or service (or both).

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

In the drawings, wherein similar reference characters denote similar elements throughout the several views:

FIG. 1 shows an overview of one method of the invention according to a first exemplary embodiment of the present invention;

FIG. 2 shows a schematic depiction of network designed to achieve the methods of the invention according to the first and second exemplary embodiments of the present invention;

FIG. 3A shows the steps involving the second stage of the lending process according to the first exemplary embodiment of the present invention;

FIG. 3B shows the steps involving the third stage of the lending process according to the first exemplary embodiment of the present invention;

FIG. 4 shows the steps of the fourth stage of the lending process according to the first exemplary embodiment of the present invention;

FIG. 5 shows the steps of the fifth stage of the lending process according to the first exemplary embodiment of the present invention;

FIG. 6 shows a schematic of the filter process, matching an individual lender to an individual borrower according to the first exemplary embodiment of the present invention;

FIG. 7 shows the lending process where an individual lender selects from a plurality of borrowers according to the first exemplary embodiment of the present invention;

FIG. 8 shows the steps of the sixth stage of the lending process according to the first exemplary embodiment of the present invention;

FIG. 9a shows a schematic of the seventh stage of the lending process according to the first exemplary embodiment of the present invention;

FIG. 9b shows the various transfer methods in the eighth stage of the lending process according to the first exemplary embodiment of the present invention;

FIG. 10 shows the steps of the Active File Transfer System in the eighth stage in the of the lending process according to the first exemplary embodiment of the present invention;

FIG. 11 shows the steps of the Active File Transfer System in the ninth stage of the lending process according to the first exemplary embodiment of the present invention;

FIG. 12 shows the tenth stage of the lending process according to the first exemplary embodiment of the present invention;

FIG. 13 shows an exemplary display screen that illustrates a variety of service options for a database that may be made available to a financial service provider according to a second exemplary embodiment of the present invention;

FIG. 14 shows an exemplary display screen that illustrates existing qualification form (QF) queries that were created and can be edited by a single financial service provider who has access to the qualification form database according to a second exemplary embodiment of the present invention;

FIG. 15A shows a first portion of an exemplary display screen that illustrates how a qualification form query can be edited or created by a financial service provider according to a second exemplary embodiment of the present invention;

FIG. 15B shows a second portion of an exemplary display screen that illustrates how a qualification form query can be edited or created by a financial service provider according to a second exemplary embodiment of the present invention;

FIG. 16A shows a first portion of an exemplary display screen that illustrates how fields of qualification forms (QFs) can be selected by a financial service provider in order to make customized queries according to a second exemplary embodiment of the present invention;

FIG. 16B shows a second portion of an exemplary display screen that illustrates how fields of qualification forms (QFs) can be selected by a financial service provider in order to make customized queries according to a second exemplary embodiment of the present invention;

FIG. 17A shows a first portion of an exemplary display screen that illustrates results of a query where a financial service provider can select individual qualification forms (QFs) according to a second exemplary embodiment of the present invention;

FIG. 17B shows a second portion of an exemplary display screen that illustrates results of a query where a financial service provider can select individual qualification forms (QFs) according to a second exemplary embodiment of the present invention;

FIG. 18 shows an exemplary display screen that illustrates additional information that can be provided to a financial service provider who is considering whether to purchase a particular qualification form of interest according to a second exemplary embodiment of the present invention;

FIG. 19 shows an exemplary display screen that illustrates qualification forms having an identification number that were selected by a financial service provider and are awaiting confirmation of purchase by the financial service provider according to a second exemplary embodiment of the present invention.

FIG. 20 shows an overview of one method of the invention and a relationship between the first exemplary embodiment and second exemplary embodiment of the present invention;

FIG. 21A shows a method for selecting qualification forms according to a second exemplary embodiment of the present invention; and

FIG. 21B shows a remainder of steps continuing from the method illustrated in FIG. 21 according to a second exemplary embodiment of the present invention.

### DETAILED DESCRIPTION OF THE PREFERRED EMBODIMENTS

Essentially, the invention according to the first exemplary aspect is a process and a computer for coordinating loans between lending institutions and borrowers via the Internet using a first automated filter. The invention according to the second exemplary aspect is a process whereby financial service providers can customize a second semi-manual filter to select individual qualification forms left over in a database from the automated process of the first exemplary aspect.

Those skilled in the art will appreciate that the present invention may be implemented with many different types of computer system configurations, including hand-held devices, multiprocessor systems, microprocessor based or programmable consumer electronics, network person computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

The present invention can also include multiple computer programs which embody the functions described herein and illustrated in the exemplary display screens and the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the exemplary display screens and flow charts and associated description in the application text, for example.

Therefore, disclosure of a particular set of program code instructions is not considered necessary for an adequate understanding how to make and use the invention. The inventive functionality of the claimed computer program will be explained in more detail in the following description in conjunction with the remaining Figures illustrating the functions and program flow.

Certain steps in the program flow described below must naturally precede others for the present invention to function as described. However, the present invention is not limited to the order of the steps described if such order or sequence does not alter the functionality of the present invention. That is, it is recognized that some steps may be performed before or after other steps or in parallel with other steps without departing from the scope and spirit of the present invention.

### First Exemplary Aspect

### Automatic Selection of Qualification Forms

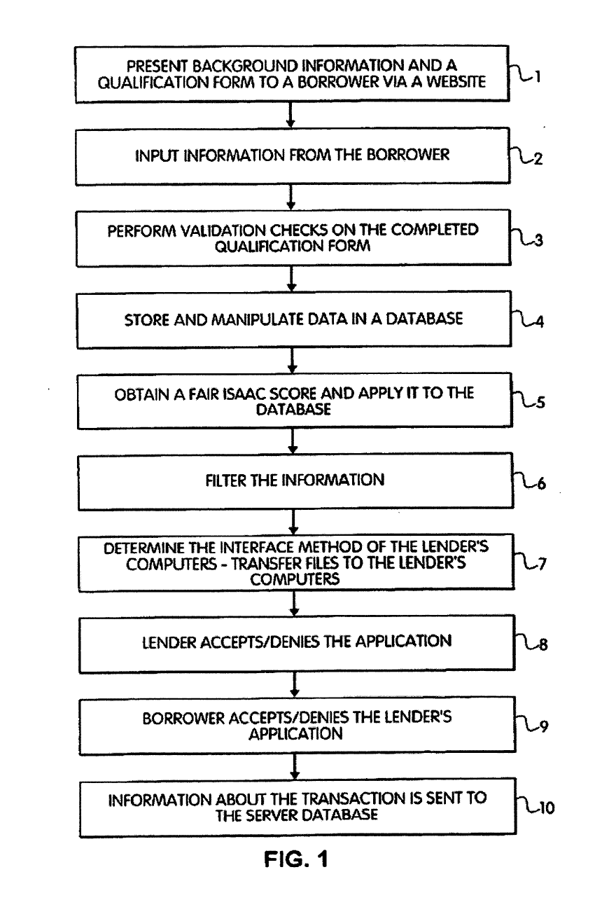

Exemplary embodiments of the present invention will hereinafter be described with reference to the drawings, in which like numerals represent like elements throughout the several figures. Referring now to FIG. 1, this figure illustrates the ten general stages in the first exemplary process required to coordinate an electronic credit application or qualification form between a prospective borrower and a plurality of lending institutions. For example, in stage 1 the process presents background information and a credit application to a prospective borrower-Internet user on a web site. In stage 2, the prospective borrower inputs information onto the web site. In stage 3, validation checks are performed on this information to make sure that the application is complete and correct. Next, stage 4 involves storing and manipulating the credit application in a database. In stage 5, a Fair Isaac Credit Score is obtained based upon the credit application and that score is matched to the application and stored in the database.

Next, in stage 6, the application is filtered where it is compared to a list of criteria presented by a series of lending institutions. If the application passes this list of criteria then in stage 7 the application is sent to each one of those institutions whose criteria match with the application. In stage 8, the lender processes the application and can either accept or deny it. If the lender accepts the application then in stage 9, the borrower can reply stating whether he accepts or denies the lender's application. Finally, in stage 10, information about this transaction is sent to a database to allow lending institutions to have access to their lending history.

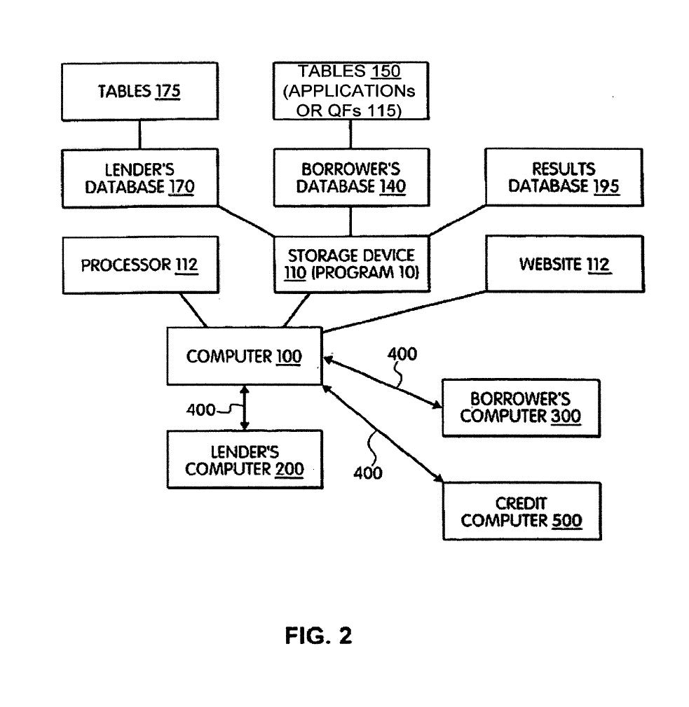

For this process to occur, there must be a series of computers connected to each other via telecommunication lines as shown in FIG. 2. Here, computer program 10, controls the process and is housed on loan processing computer 100. Loan processing computer 100 coordinates a loan application between a series of lending institution computers 200, and a plurality of borrower computers 300. Computer program 10 is stored on loan processing computer 100 in storage device 110 and is run by processor 112. Program 10 is designed to transmit and receive information through the Internet via a web browser such as Netscape or Internet Explorer, installed on the computers.

Loan processing computer 100 must have sufficient memory and processor power to project program 10 over the Internet. Therefore, the recommended minimum requirements for processor 12 on computer 100 is an Intel Pentium 200 Mhz processor. The remaining standard components are 64 megabytes of ram, 2 gigabytes of disk space, an Internet connection, additional Ethernet connection, and Windows NT workstation operating system. Computer 100 is installed with one Ethernet interface directly on the Internet, and the other Ethernet interface is connected to a firewall storage device 110, to allow disposition of files on a designated server inside the corporate network. In addition computer 100 could be a Unix style server that interfaces with other Unix and non-Unix based computers on the Internet.

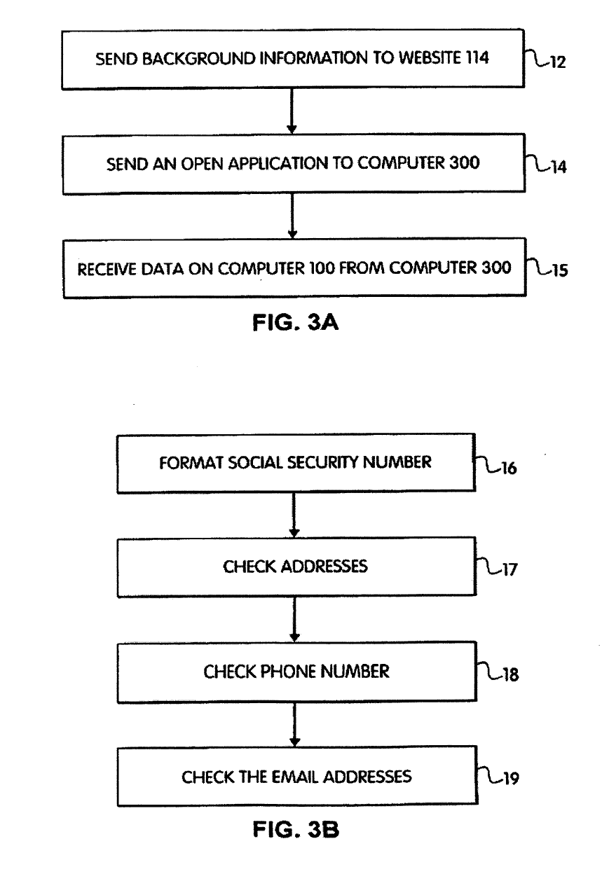

When program 10 runs on computer 100 it instructs computer 100 to interact with other computers through the Internet to co-ordinate a loan application. For example, as shown in FIGS. 1 and 2, in stage 1, computer 100 allows lender computers 200 to access information on web-page 114 housed in loan processing computer 100 at a predetermined URL address via telecommunication lines 400. In stage 2, computer 100 allows prospective borrowers using satellite computers 300 to view a plurality of documents provided by computer 100. Stage 2 consists of a series of steps that are shown in FIG. 3a. For example, in step 12, computer 100 sends the prospective borrower background information documents to web-site 114 concerning the loan application. These background information documents include a document welcoming the Internet user to the web site, a document explaining the application process, and a document explaining the services provided. In step 14, computer 100 sends an open application to a prospective borrower through the Internet to computer 300. In step 15, the prospective borrower inputs information onto the application. When the prospective borrower wants to send this information back to computer 100 he clicks a “SEND” button which initiates the third stage of the program.

Referring now to FIG. 3b, this figure outlines stage 3 wherein computer 100 sends a series of instructions to computer 300 to initiate edit and validation checks. In step 16, computer 100 checks the Social Security number entered. In step 17 computer 100 checks the addresses, in step 18 it checks phone numbers, and in step 19 it checks the email addresses entered. The edit and validation checks in stage 3 insure that the data to be received by the database 140 in computer 100 is in the proper format for further processing. If computer 100 determines that the data is in the proper format, then the borrower can then transmit a completed application 115 to a database on computer 100.

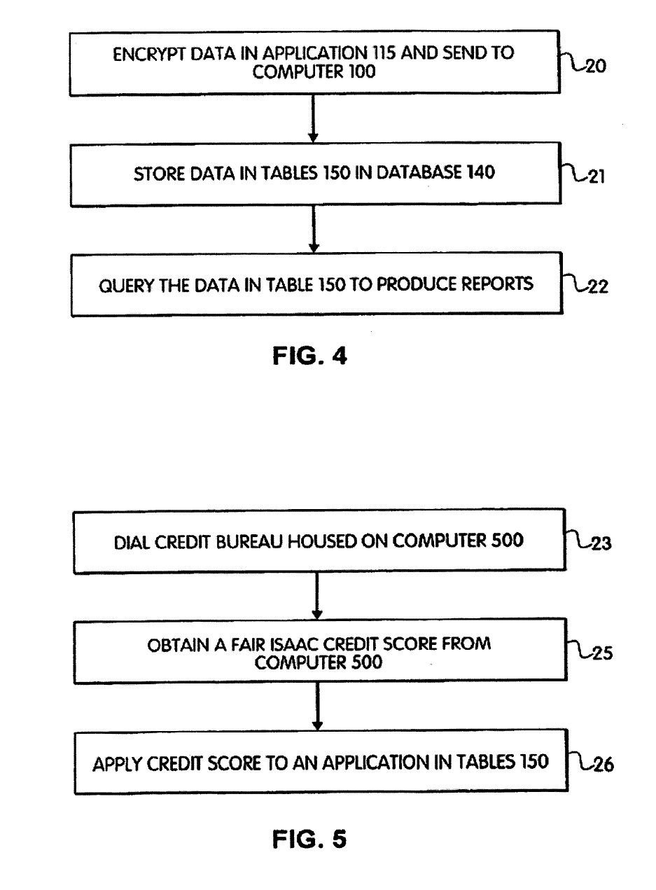

Referring now to FIG. 4, this figure shows stage 4, wherein in step 20 the data from the completed application 115 is encrypted by SSL technology. Next in step 21, at the borrowers instruction, this information is sent to computer 100, unlocked and stored in storage device 110 for further manipulation. In this stage, the data from completed application 115 is sorted and stored in tables 150 in database 140 based on the type of loan requested (i.e. mortgage, home equity, credit card, etc.). Next, in step 22, program 10 queries the data from tables 150 to produce reports providing loan information based on data given any field in the application form (i.e., state of residence, borrower income, etc.).

Referring now to FIG. 5, in this figure, computer 100 moves into stage 5, wherein in step 23, computer 100 dials to a credit bureau housed on Credit Computer 500 via telecommunication lines 400. In step 25, computer 100 obtains a Fair Isaac Credit Score from computer 500 based upon the data sent to computer 500. Next, in step 26, computer 100 inputs the Fair Isaac Credit Score to the database tables 150. The lenders can use this Fair Isaac Credit Score as one determinant to the borrower's credit risk.

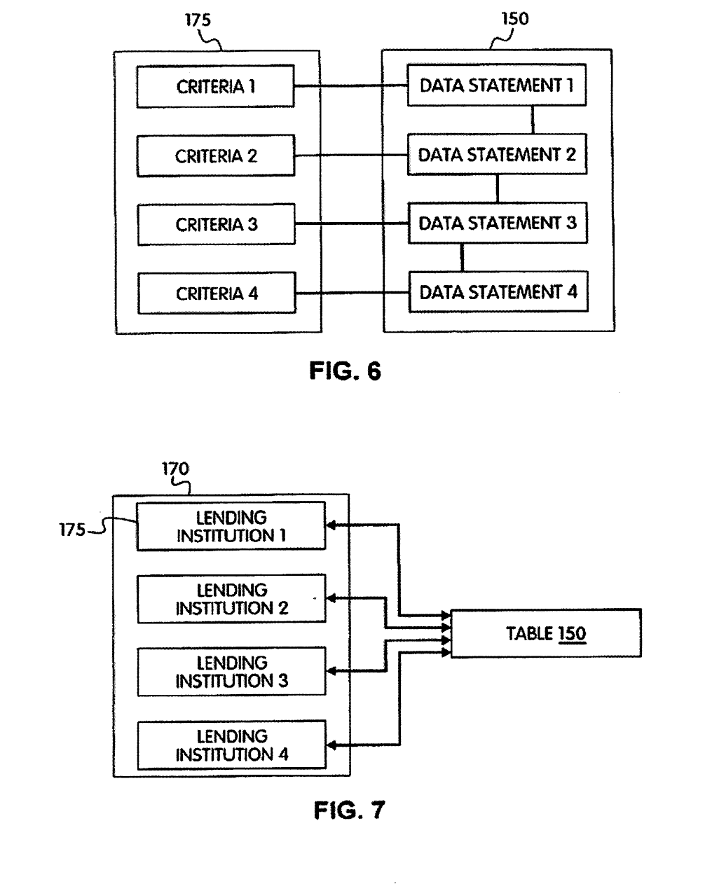

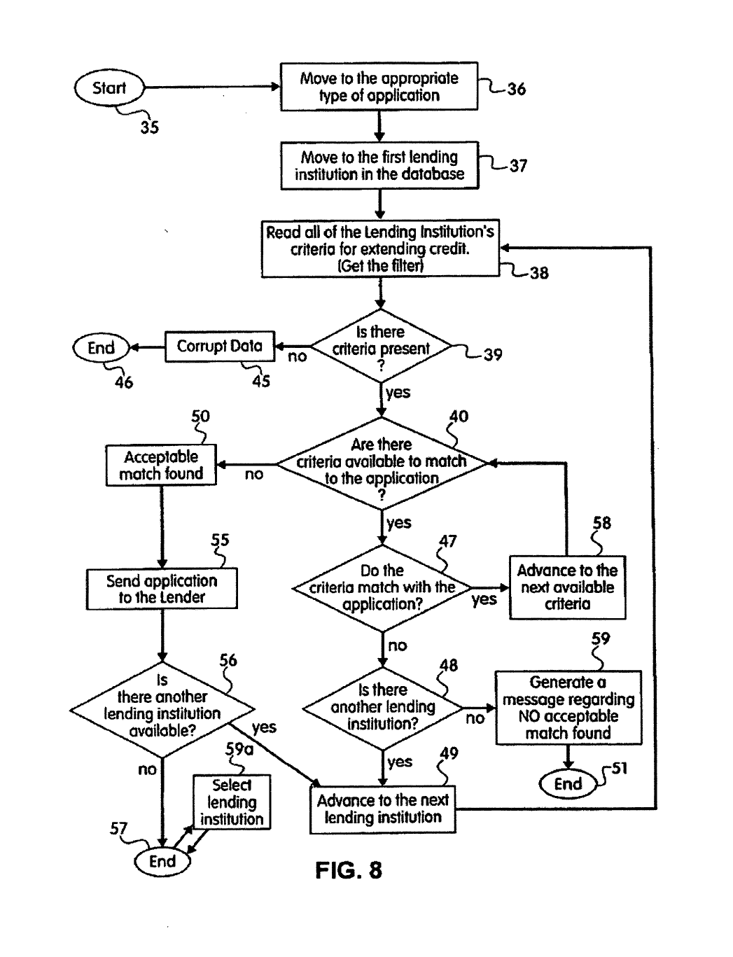

Referring now to FIGS. 6, 7, and 8, these figures show stage 6 of the process, wherein computer 100 runs a filter to match completed application 115 in table 150 against preset criteria established by each lender. As shown in FIG. 6, lender criteria are stored in tables 175 in lender database 170 on computer 100. Wherein in FIG. 7 lender database 170 includes a listing of tables 175 for several lending institutions. The process for matching borrower's application in tables 150 to lender criteria in tables 175 is shown in FIG. 8. For example, in step 35, program 10 starts the filter process. Next, in step 36, the filter process initiates and moves to the appropriate type application 115 in tables 150. Next, in step 37 the filter moves to a first lending institution in table 175. In step 38, program 10 instructs computer 100 to read all of the lending institution's criteria for extending credit. In step 39, program 10 reads whether there are any criteria present in tables 175. If the requested data is not present, next, in step 45 the filter checks to see if there is any database connection that is broken and whether the database information in the message. If the criteria are present, step 40 instructs computer 100 to see whether any remaining criteria to match to application 115 stored on tables 150.

If there are more criteria to match to application 115, then in step 47, program 10 checks to see whether that remaining criteria matches with application 115. If the criteria matches with application 115 then in step 58, program 10 advances to the next available criteria in tables 175. As shown in FIG. 6, step 58 creates a loop back to step 40. If the criteria does not match with application 115, then in step 48, program 10 checks to see whether there is another lending institution in database 170. If there are no remaining lending institutions in database 170 then in step 59, computer 100 generates a message that no acceptable match has been found. After this message, in step 51, the filter process ends.

If there is another lending institution found, then the filter process advances to another lending institution in step 49. Step 49 creates a loop back to step 38 wherein the filter process reads all of the criteria for the new lending institution. This loop continues until in step 40, the filter finds there are no criteria available to match to completed application 115.

If there are no more criteria to match to application 115, then in step 50, the filter determines whether there has been an acceptable match between a borrower and a lender. If there is an acceptable match, then in step 55 the filter selects that lender as a suitable lender for application 115.

In step 56 program 10 checks to see if there is another lending institution available, if yes, then program 10 advances to the next lending institution in step 49. If there are no more lending institutions available, then program 10 advances to step 57 wherein the filter process ends. Finally in step 59a computer 100 selects a limited number of matched lending institutions in which to send application 115. For example, if the filter process matches application 115 with 20 lending institutions, computer 100 may send application 115 to only a fraction of those matched lending institutions. This selection process in step 58 is based upon either random selection or a predetermined set of criteria stored in computer 100.

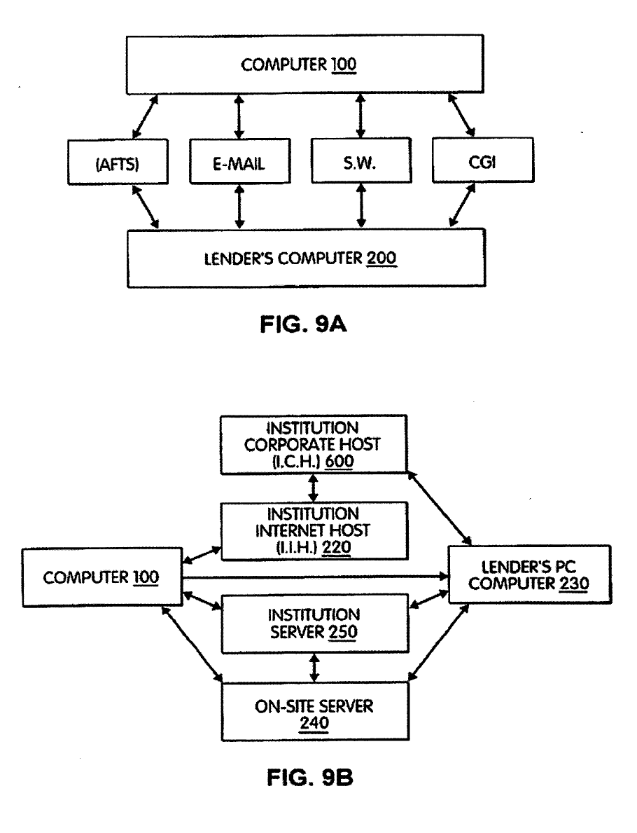

Next, as illustrated in FIG. 9a in stage 7, program 10 determines the interface method between computer 100 and the selected lending institution computers 200. The interface method can be Common Gateway Interface (CGI), Active File Transfer (AFTS), as a secured file on a secured webpage (S.W.) or via e-mail. Stage 7 allows loan computer 100 to access many different lender sites which thereby allows for greater communication flexibility within the system.

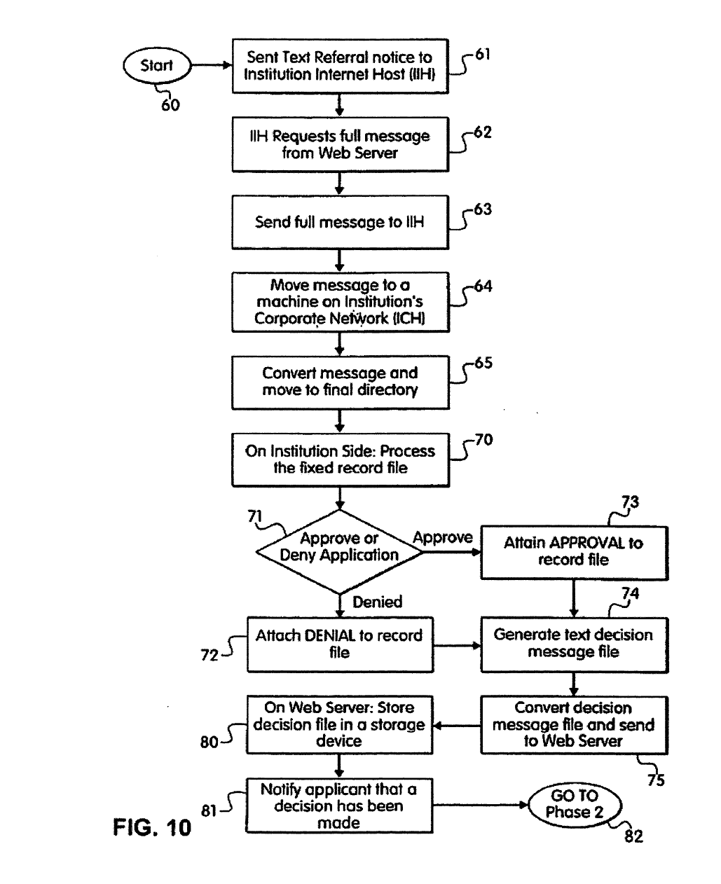

In stage 8, as shown in FIGS. 9a, 9b and 10, computer 100 sends data from table 150 via the interface method selected in stage 7 to the lending institutions selected in the filter process of stage 6. FIG. 10 shows the Active File Transfer System (AFTS) of FIG. 9b in greater detail. For example, in step 60, program 10 instructs computer 100 to start the AFTS. Next, in step 61a text referral notice is sent to The Institution Internet Host (IIH) computer 220. In step 62, IIH computer 220 requests a full message from computer 100. In step 63 computer 100 sends an encrypted full message to IIH computer 220. Next, in step 64 computer 200 moves the message to the Institution's Corporate Network (ICH) 600. In step 65, ICH 600 converts the message from HTML format to a customized fixed record format defined and controlled by the destination institution. Next, in step 70, outside program 10, this information can be processed and stored in the lender's system. In step 71 the lender approves or denies application 115. If the lending institution approves application 115 it attaches an approval to the record file in step 73.

Alternatively if the lending institution denies application 115, then in step 72 it attaches a denial to the record file. In step 74, the lender computers 700 generate a text decision message file. This message file is converted from the existing format into HTML format and sent to computer 100 web-site via encrypted transmission in step 75. The text decision message file contains a loan id number and a request for more information from the borrower. Computer 100 next stores the decision file in database 180 in step 80. Next, in step 81, computer 100 notifies an applicant that a decision has been made.

In addition, the data from credit application 115 can also be sent via e-mail with Pretty Good Privacy (PGP) encryption as shown in FIG. 9b. PGP is an encryption program that can be used to encrypt, a binary file to someone, with very high security, without having to exchange a set of private encryption keys beforehand. In this style transfer system, the text of table 150 comprising credit application 115, is transformed into an e-mail text message. Next, the e-mail message is encrypted in PGP format. Finally, computer 100 sends the e-mail message to computer 230 which is a remote networked computer on a lending institution's site.

The third transfer process, that of the secured dynamic website serves as a place for lenders to log in to a website to change their lending criteria filters and to view loan applications. In this process, information is stored on computer 100 in a website that can be accessed by a lender. To access this site, a lender is given a login access account to log into the website that is encrypted by SSL technology. Once the lender logs into the website he can download information relating to a borrower's request for information.

In the fourth transfer method, the Common Gateway Interface (CGI) format is shown in FIG. 9b. There, computer 100 sends data from table 150 to institution server 250 via a Common Gateway Interface (CGI) program. CGI programs allow for a server to server interface over which encrypted information can be transferred. For example, the data located on table 150 is first encrypted. Next the data can be sent from computer 100 to institution server 250. Server 250 next stores and unlocks the encrypted data. This unlocked data can then be read by all other networked computers 230 in a lender's home network.

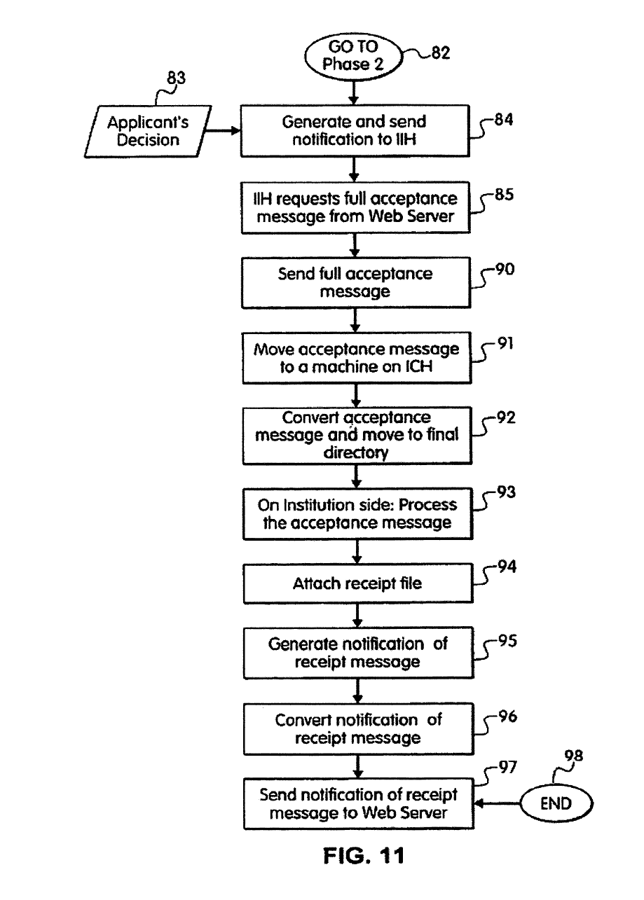

In stage 9, as shown in FIG. 11, computer program 10 moves into the second phase of (AFTS) in step 82. In this stage, the borrower informs the lender of his decision concerning the loan. For example, in step 83 a borrower sends his decision notification from computer 300 to computer 100. Next, in step 84, computer 100 generates and sends a notification to computer 220 (IIH). In step, 85 computer 100 sends a full acceptance message to IIH computer 220 and next moves the acceptance message to ICH computer 600 in step 90. After that, in step 91 ICH computer 600 converts the acceptance message from HTML format and moves it to a final directory 190 on computer 230 (step 91).

At this point the lending institution program takes over so that in step 93, institution computer 230 processes the acceptance message. In step 94, institution computer 230 attaches a receipt file to the acceptance message. In step 95, institution computer 230 generates a notification of receipt message, and in step 96, it converts the notification from its standard database format into HTML format. Finally, in step 97 ICH computer 600 sends a notification of the receipt message to computer 100 and in step 98 the Active File Transfer System ends.

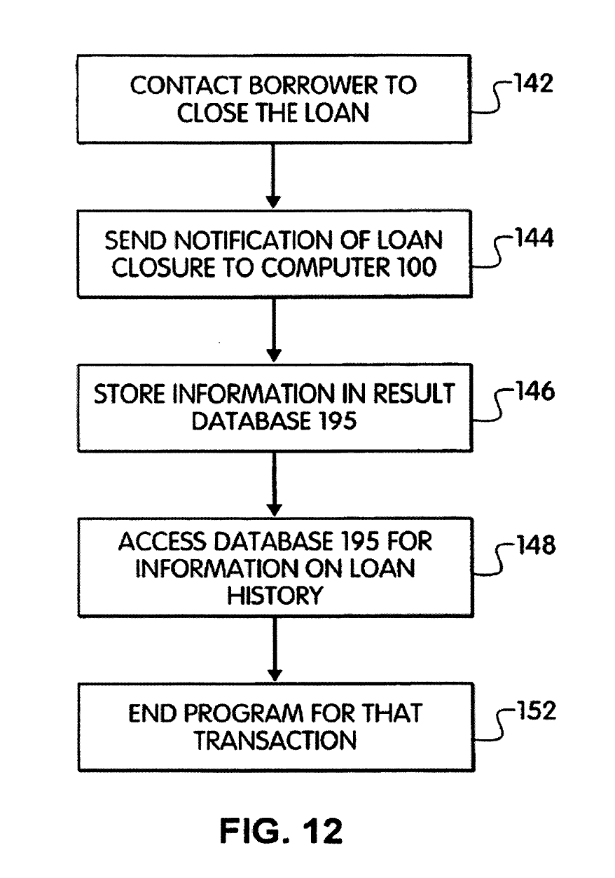

In the tenth and final stage, as shown in FIG. 12, in step 142 the lender contacts the borrower to coordinate the closing of the loan. Here, the lending institution has the borrower's name, social security number, application id number, phone number at both work and home, and the best time to contact the borrower from the acceptance email sent when the offer was accepted. The loan closing can take place in any way that the lender typically closes loans. Once all documents are signed and delivered from the borrower, the loan is closed. Once the lender closes a loan, in step 144 it contacts computer 100 and sends a notification of the loan closure. In step 146 computer 100 stores this information in result database 195 which can be accessed by the lenders in step 148. Finally in step 152, the process according to the invention ends for that individual transaction.

### Second Exemplary Aspect

### Semi-Manual Selection of Qualification Forms by Financial Service Providers

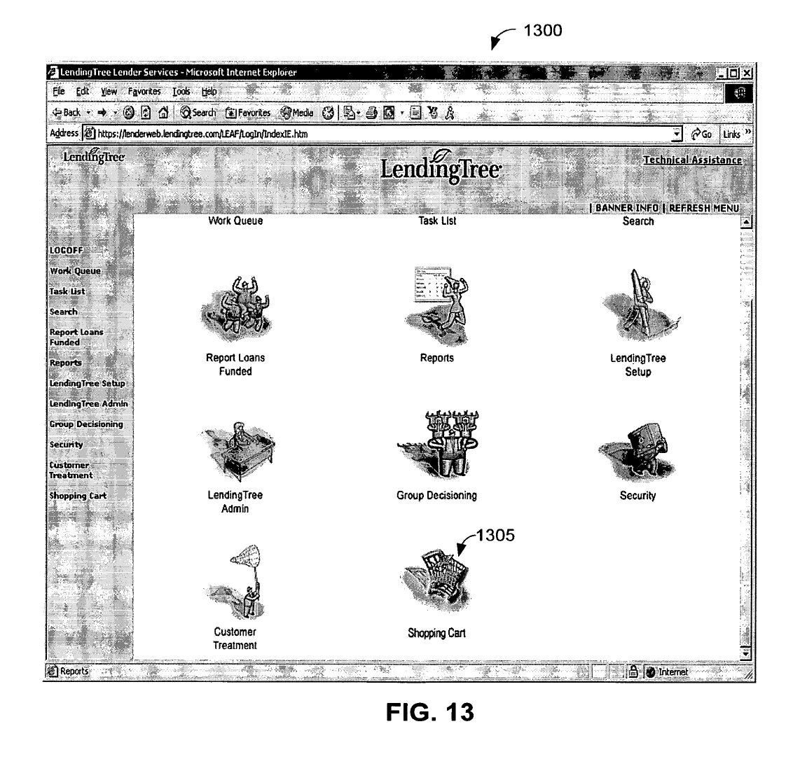

Referring now to FIG. 13, this figure shows an exemplary display screen 1300 that illustrates a variety of service options of a database 150 that may be available to a financial service provider according to a second exemplary embodiment of the present invention. One option that is available to financial service providers and that is displayed on the exemplary display screen 1300 is the “Shopping Cart” option 1305. By selecting the shopping cart option 1305, a financial service provider can initiate a method for selecting qualification forms according the second exemplary embodiment of the present invention. This method for selecting qualification forms according to the second exemplary aspect can be performed by a portion or a module of the program 10 described above with respect to FIG. 2.

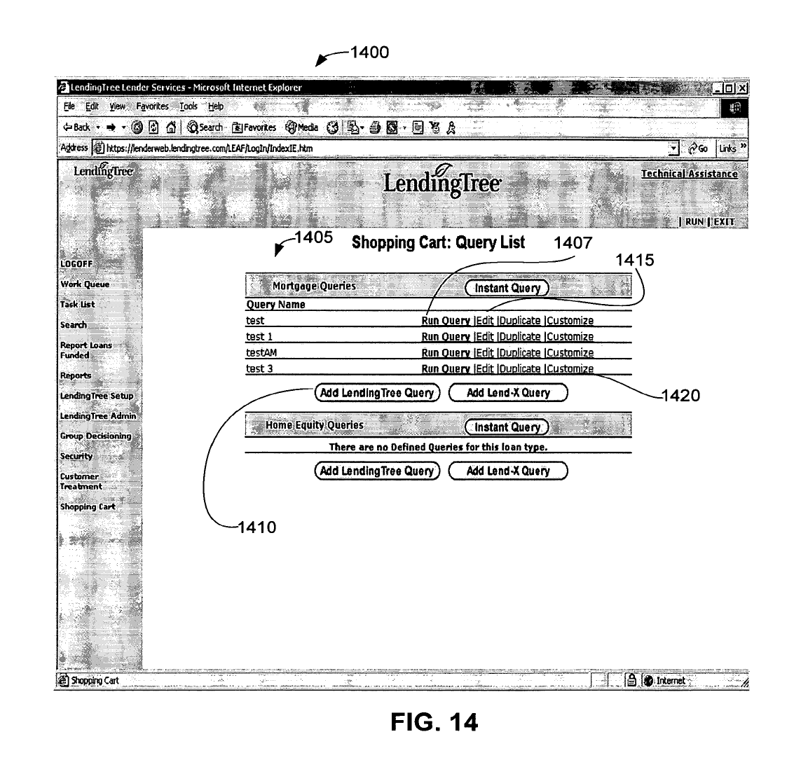

Referring now to FIG. 14, this figure shows an exemplary display screen 1400 that illustrates existing qualification form queries 1405 that were created and can be edited by a single financial service provider who has access to the tables or qualification form database 150 according to a second exemplary embodiment of the present invention. Each qualification form query can be assigned a name that is chosen by a financial service provider. For example, as illustrated in FIG. 14, a financial service provider could identify four queries with the following four names: test, test 1, testAM, and test 3.

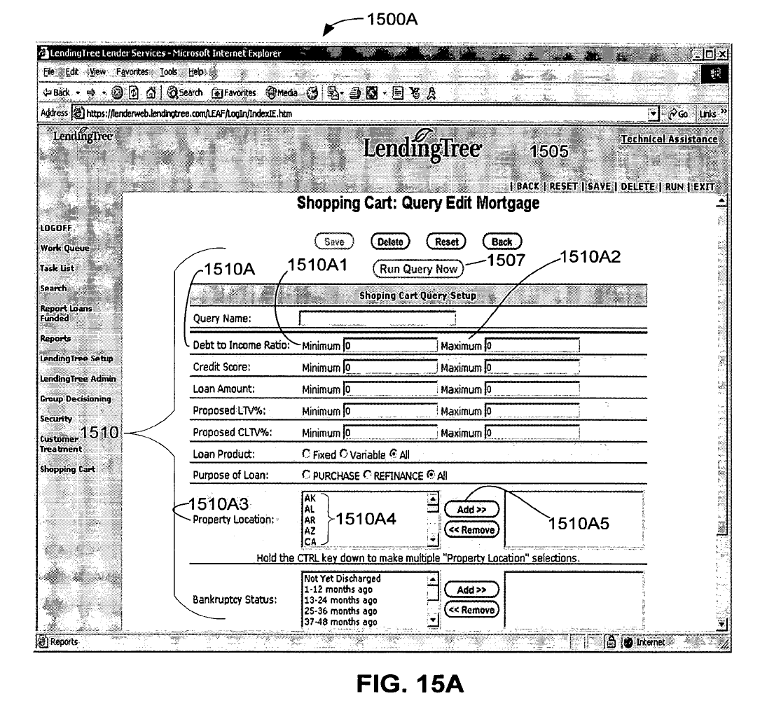

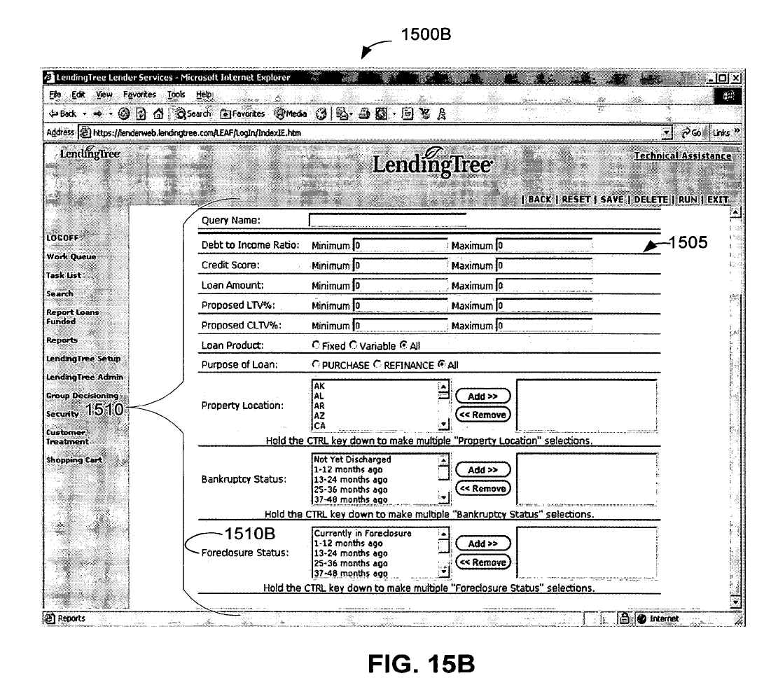

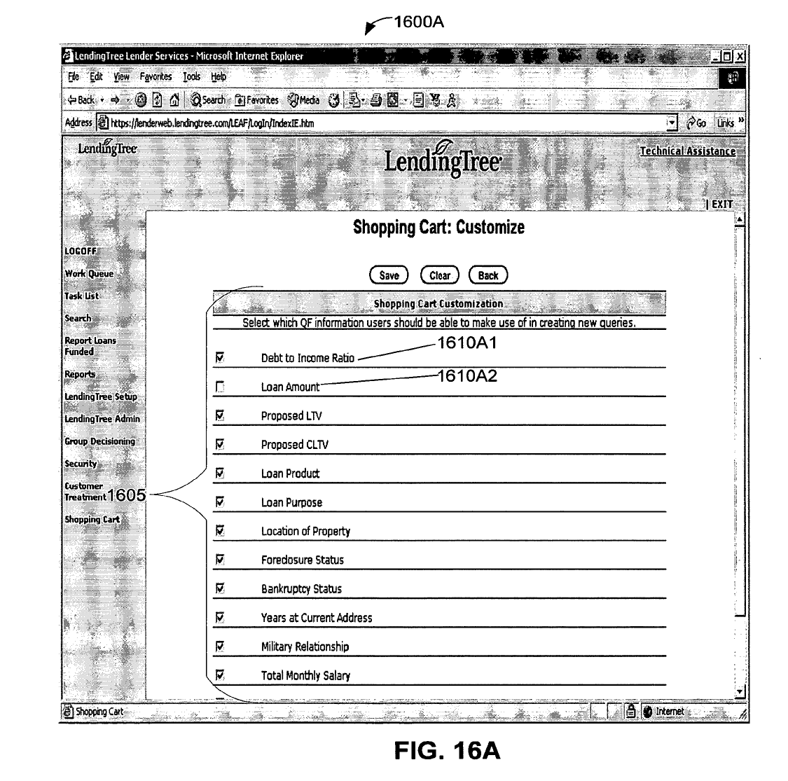

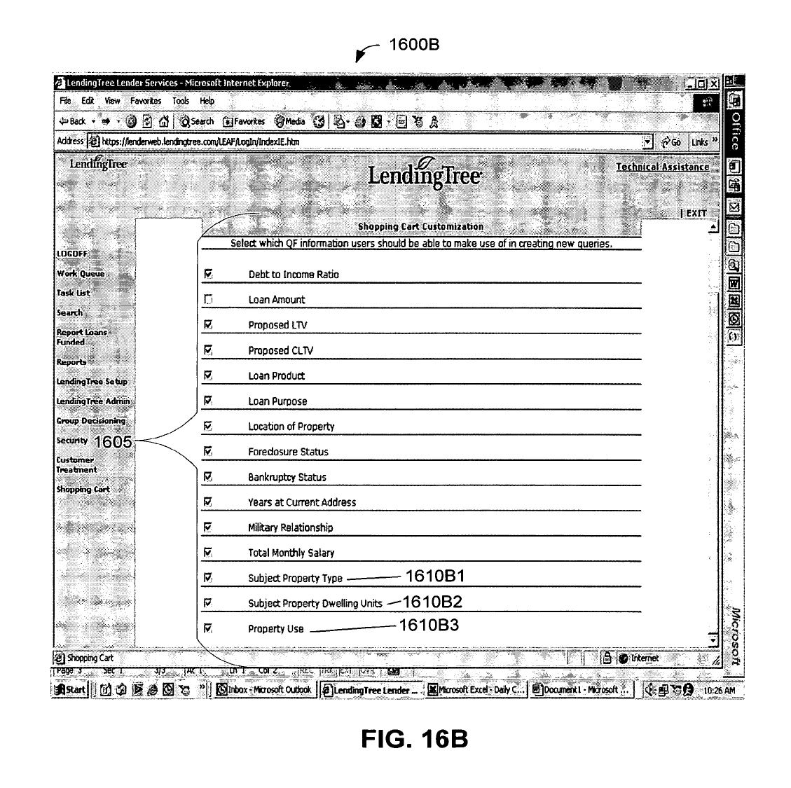

For each existing and named query, a financial service provider can run or execute the query again in order to search for recently added qualification forms that have been added to the database 150 since the last execution of the query. Each financial service provider can also edit, duplicate, or further customize an existing and named query. Further, a financial service provider can formulate a new qualification form query by selecting the “Add LendingTree Query” button 1410. If the financial service provider selects “Add LendingTree Query” button 1410, then the exemplary display screen 1500A as illustrated in FIG. 15A is shown. Similarly, if a financial service provider selects the “Customize” option 1420 of FIG. 14, then the exemplary display screen 1600A of FIG. 16A is shown.

Referring now to FIG. 15A, this figure shows a first portion 1500A of an exemplary display screen that illustrates how a qualification form query can be edited or created by a financial service provider according to a second exemplary embodiment of the present invention. While not shown in FIG. 15A, a financial service provider can be provided with at least two options in which a financial service provider can select from at least one of a mortgage and home equity qualification forms. Those skilled in the art recognize that other qualification forms could be classified or placed in categories and could be made available for selection by a financial service provider. The present invention is not limited to only mortgage or home equity type qualification forms.

In FIG. 15A, an exemplary mortgage query is illustrated. The query can comprise a plurality of fields. Table 1 illustrates some exemplary fields that can be part of either a mortgage or home equity query:

TABLE 1
Exemplary Qualification Form Query Fields
Field Name
Debt to Income Ratio
FICO Score Range*
Bankruptcy Status
Foreclosure Status
Loan Purpose*
Loan Amount*
Loan Product
Proposed LTV*
Proposed CLTV
Location of Property*

Those skilled in the art recognize that additional or fewer fields for a particular query are not beyond the scope and spirit of the present invention. According to one exemplary embodiment, one or several fields may be required in order to execute the particular query. For example, according to one exemplary embodiment, a FICO score range field, a loan purpose field, and a location of property field (see fields marked with an asterisk in Table 1) may be required to perform either a mortgage or home equity type of query. Those skilled in the art will recognize that other fields may be required for different types of queries.

Each field 1510 may comprise various options that can be selected by a financial service provider. For example, in the debt to income ratio field 1510A, a financial service provider could insert a low value in a minimum amount field 1510A1. Similarly, a financial service provider could insert a maximum amount for the debt to income ratio in a maximum amount field 1510A2.

The present invention is not limited to any number, types, or formats of fields that can be searched or queried by a financial service provider. For example, for a home equity or mortgage query, a property location field 1510A3 can be searched by the financial service provider. The financial service provider could select several property locations based on the state of the property location by selecting several of the state abbreviations 1510A4 in selecting the “Add” button 1510A5 with a pointer.

Referring now to FIG. 15B, this figure shows a second portion 1500B of an exemplary display screen that illustrates how the qualification form query 1505 can be edited or created by a financial service provider. In the second portion 1500B, an additional field such as a foreclosure status field 1510B is illustrated. As noted above, the present invention is not limited to the number, type, or format of fields that can be selected by a financial service provider in order to perform a search of qualification forms stored in the database 150.

Referring now to FIG. 16A, this figure shows a first portion 1600A of an exemplary display screen that illustrates how fields of qualification forms can be selected by a financial service provider in order to make customized queries according to a second and exemplary embodiment of the present invention. According to this feature of the invention, a financial service provider may select or eliminate a search field 1605 for a particular query. For example, a financial service provider can select a debt to income ratio field 1610A1 while eliminating a loan amount field 1610A2 for a particular query. This means that the debt to income ratio field 1610A1 of the qualification forms stored in the database 150 will be searched while the loan amount field 1610A2 will not be searched when the query of FIG. 16A is executed by the financial service provider.

Turning now to FIG. 16B, this figure shows a second portion 1600B of an exemplary display screen that illustrates how fields of qualification forms can be selected or eliminated by a financial service provider in order to make customized queries according to a second exemplary embodiment of the present invention. Specifically, the second portion 1600B illustrates additional fields that may be available for selection or elimination by a financial service provider. In particular, the second portion 1600B illustrates a subject property type field 1610B1, a subject property dwelling units field 1610B2, and a property use field 1610B3. Table 2 below lists various types of fields that can be selected or eliminated by a particular financial service provider:

TABLE 2
Qualification Form Query Fields that Can be
Selected or Removed from a Query

| QF Number | Property Type |
|---|---|
| Debt to Income Ratio | FICO Score |
| Bankruptcy Status | Foreclosure Status |
| Loan Purpose | Loan Amount |
| Loan Product | Proposed LTV |
| Proposed CLTV | Location of Property |
| Years at Current | Total Monthly Salary |
| Address | |
| Military Relationship | Property Use |
| Total Monthly | Number of Units |
| Income | |

As noted above, the present invention is not limited to the number, type, or format of fields that can be used by financial service providers to determine if a financial service or financial product (or both) should be offered to a particular consumer. Additional or fewer fields are not beyond the scope and spirit of the present invention.

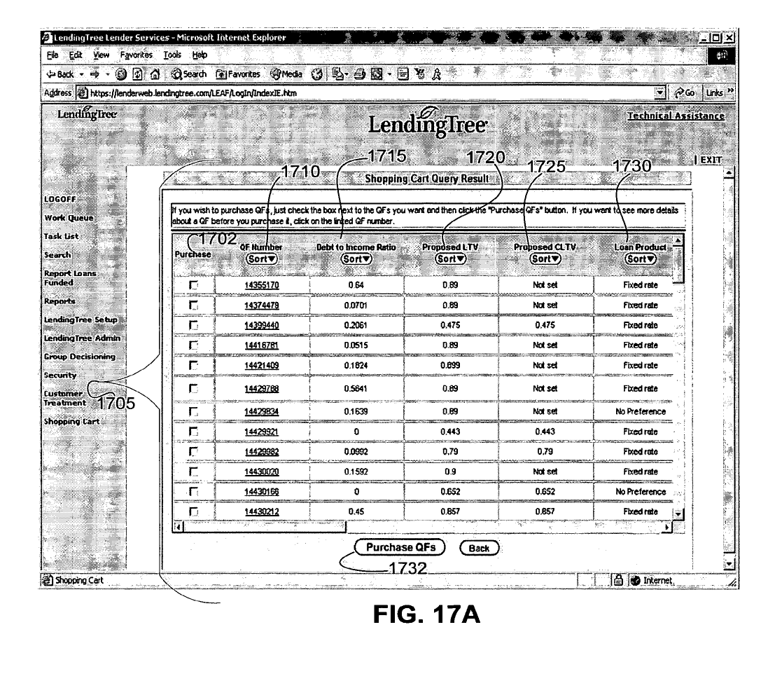

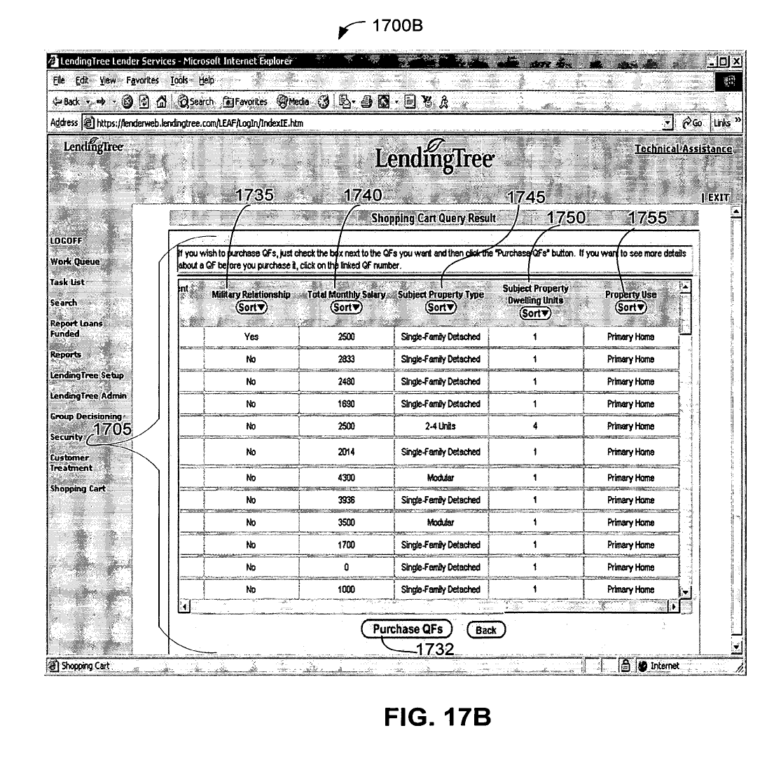

Referring now to FIG. 17A, this figure shows a first portion 1700A of an exemplary display screen that illustrates results 1705 of a query where a financial service provider can select individual qualification forms according to a second exemplary embodiment of the present invention. In the first portion 1700A, results 1705 of a query are displayed. The results 1705 can comprise qualification forms that have met the criteria of a second filter set by a financial service provider. The results 1705 can include records of data organized in columns where each column can comprise a particular field that a financial service provider selected in the customization user interface illustrated in FIG. 16.

Specifically, for the exemplary embodiment illustrated in FIG. 17, the exemplary fields can include the qualification form number column 1710, a debt to income ratio column 1715, a proposed loan to value column 1720, a proposed closing loan to value column 1725, and a loan product column 1730. The results 1705 can be organized by particular columns. For example, if a financial service provider selected the qualification form number column 1710, then the results 1705 can be sorted in a sequential order based upon the qualification form number.

The results 1705 can also include the purchase column 1702 in which the financial service provider can individually select particular qualification forms for purchase. Those skilled in the art will recognize that other mechanisms or ways of selecting qualification forms by the financial service provider will not be beyond the scope and spirit of the present invention. For example, a financial service provider could select a group of qualification forms at one time by using a pointer and a highlight feature with a mouse instead of checking boxes that are present in the purchase column 1702. When a financial service provider desires to purchase qualification forms that are displayed in the results 1705, the financial service provider can select a purchase QSs button 1732.

Referring now to FIG. 17B, this figure shows a second portion 1700B of an exemplary display screen that illustrates results 1705 with a query where a financial service provider can select individual qualification forms according to a second exemplary embodiment of the present invention. The second portion 1700B further illustrates additional columns that can be used to sort and organize the results 1705 of the particular query.

In the exemplary embodiment illustrated in FIG. 17B, the columns can include a military relationship column 1735, a total monthly salary column 1740, a subject property type column 1745, a subject property dwelling units column 1750, and a property use column 1755. As noted above, additional or fewer fields or columns are not beyond the scope and spirit of the present invention. Organizing the results 1705 with columns allows a financial service provider to review the results 1705 in an organized manner and in a way in which the financial service provider can view criteria that is more important for a particular financial service provider.

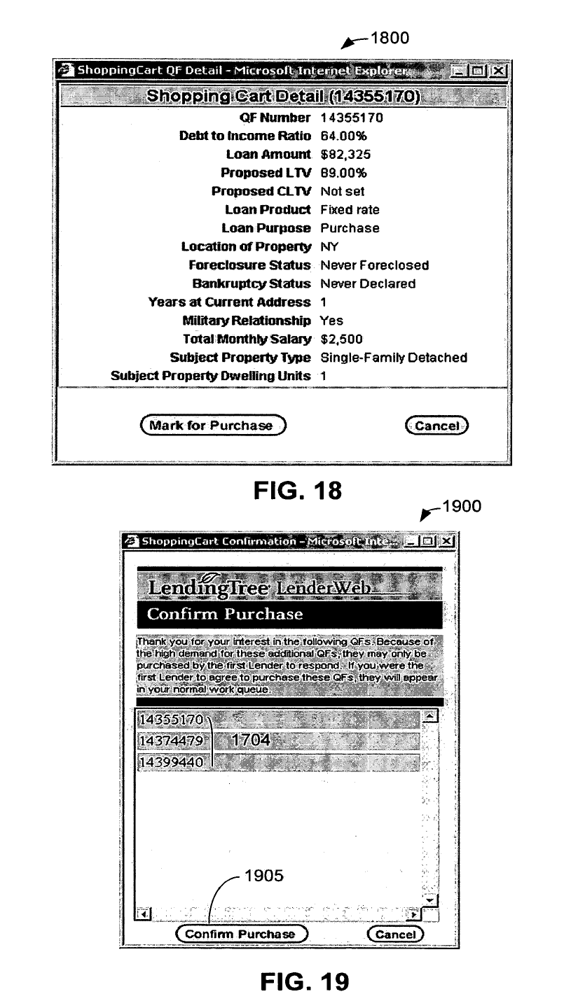

Referring now to FIG. 18, this figure shows an exemplary display screen 1800 that illustrates additional information that can be provided to a financial service provider who is considering whether to purchase a particular qualification form of interest according to a second exemplary embodiment of the present invention. Exemplary display screen 1800 is shown after a financial service provider selects a qualification form for additional information from the results Table 1705. In other words, referring briefly back to FIG. 17A, if a financial service provider desires more information about a particular qualification form, then the financial service provider can select the actual qualification form number 1704 which may comprise hyperlinked text in a hypertext markup language (HTML) environment. Therefore, if a financial service provider “double clicks” on a particular qualification form number 1704, then the exemplary display screen 1800 is shown.

Referring back to FIG. 18, the additional information displayed in the exemplary display screen 1800 can include information that may or may have not been searched or selected by the financial service provider during the query creation stage. In other words, the additional information available to a financial service provider about a particular qualification form may include information that was or was not selected by the financial service provider when creating the search query.

The intent of the information displayed in the exemplary display screen 1800 is to provide a financial service provider with enough additional information about a particular consumer that the financial service provider can make a more informed decision about whether the qualification form should be purchased so that the financial service provider can make an offer to the consumer. The information displayed in exemplary display screen 1800 typically corresponds with the fields that are available for selection by the financial service provider in customization display screens 1600 illustrated in FIG. 16.

However, those skilled in the art will recognize that additional or fewer fields may be provided in exemplary display screen 1800 without departing from the scope and spirit of the present invention. Further, the additional information contained in the exemplary display screen 1800 could include information that is not connected to a particular field that can be search by a financial service provider. The additional information contained in exemplary display screen 1800 typically is the name and address of the person who completed the qualification form. However, those skilled in the art will recognize that a name or address could be provided in the additional information exemplary display screen 1800 without departing from the scope and spirit of the present invention.

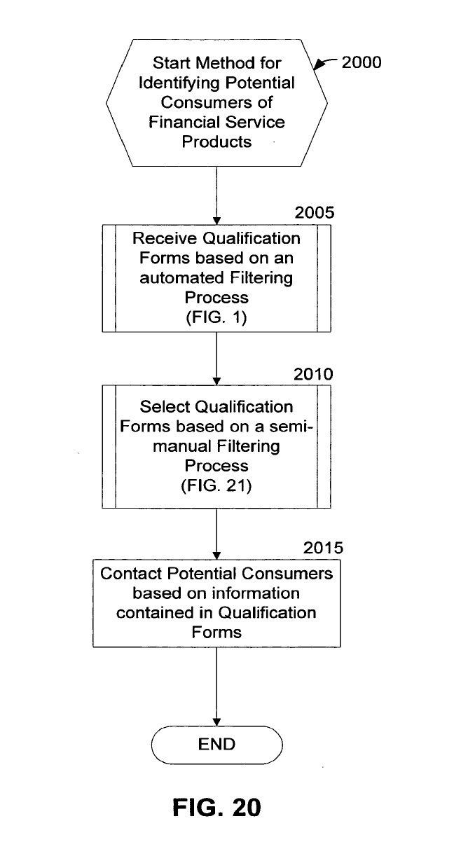

Referring now to FIG. 19, this figure shows an exemplary display screen 1900 that illustrates qualification forms having an identification number 1704 that was selected by a financial service provider and are awaiting confirmation of purchase by the financial service provider according to a second exemplary embodiment of the present invention. Generally, exemplary display screen 1900 corresponds with the qualification forms that were selected in the results Table 1705 as illustrated in FIG. 17. The qualification forms that are purchased can be displayed by their qualification form identification number 1704, however, the qualification forms that are to be purchased could also be displayed by using different fields without departing from the scope and spirit of the present invention. For example, in addition to the qualification form number 1704, the qualification forms could also be displayed with their debt to income ratio fields or proposed loan to value fields, etc.

If a financial service provider desires to purchase the qualification forms shown in the exemplary display screen 1900, then the financial service provider 1905 can select the “confirm purchase” button 1905. After selecting the confirm purchase button 1905, the financial service provider can be billed a fee for the qualification forms that have been selected.

According to one exemplary aspect of the present invention, the qualification forms in the database 150 can be subject to purchase restrictions such that each qualification form may only be purchased by a first financial service provider to respond as explained in the text in the exemplary display screen 1900. However, those skilled in the art recognize that it is not beyond the scope and spirit of the present invention in which such purchase restrictions are not used so that multiple financial service providers could obtain the same qualification forms.

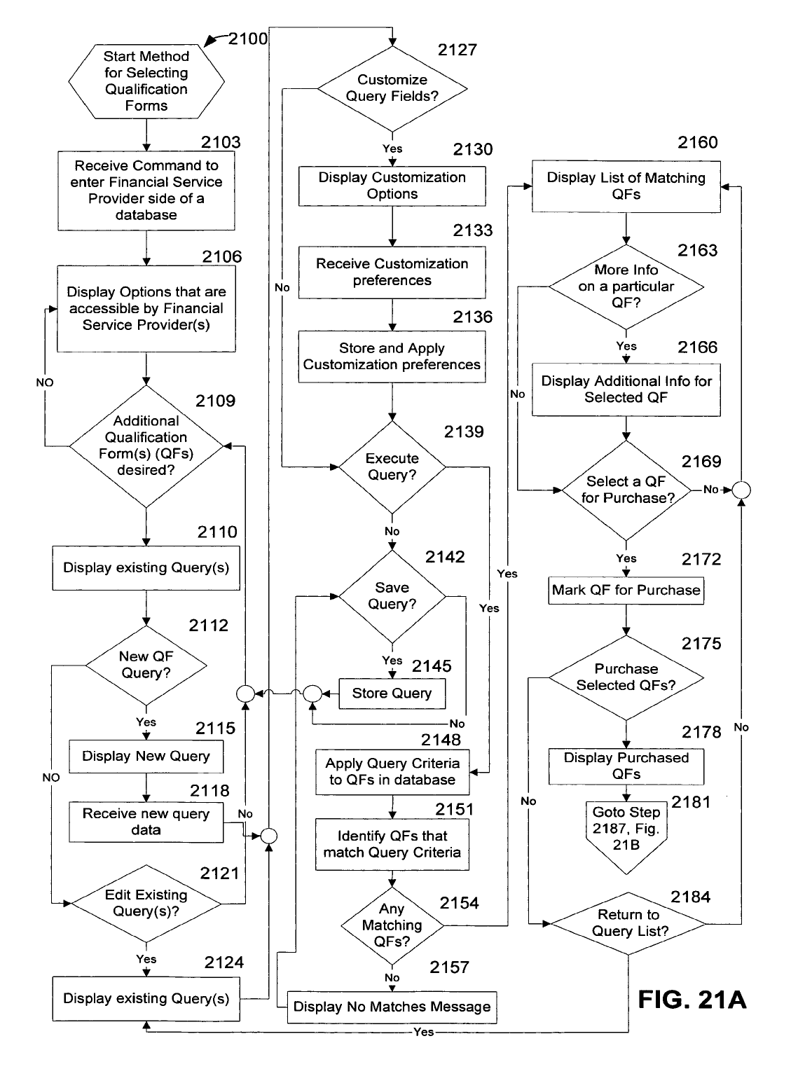

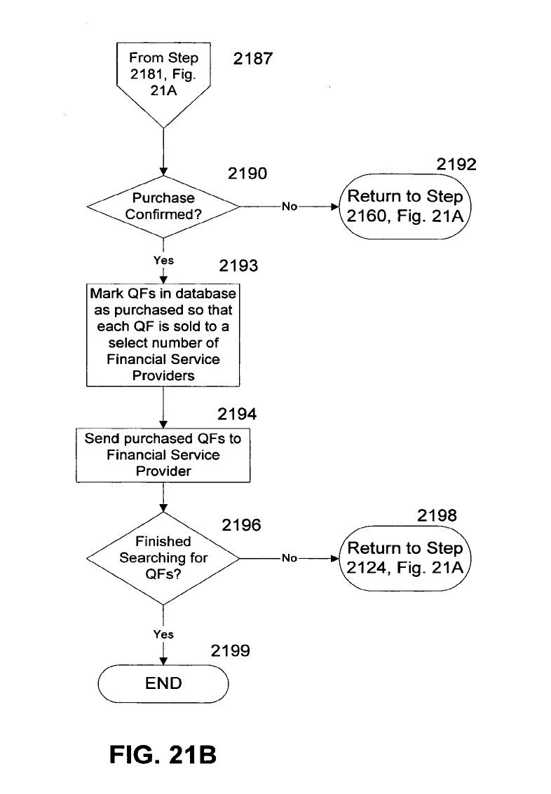

Referring now to FIG. 20, this figure illustrates an overview of one method 2000 of the invention and the relationship between the first exemplary embodiment and second exemplary embodiment of the present invention. Generally, in FIG. 20, a method 2000 for identifying potential consumers of financial service products is illustrated. In the first routine 2005, a financial service provider can receive qualification forms based on an automated filtering process as outlined and described with respect to FIG. 1. Next, in subroutine 2010, a financial service provider can select qualification forms based on a semi-manual filtering process as illustrated in FIG. 21 as will be discussed in further detail below.

The second subroutine 2010 generally involves the creation and customization of a second filter that is described in connection with the exemplary display screens illustrated in FIGS. 14 through 19. Further details of routine 2010 will be discussed below in connection with FIG. 21.

Next, in step 2015, a financial service provider can contact potential consumers based on the detailed information contained in the qualification forms. The detailed information contained in the qualification forms can include the name, address, telephone number, fax number, or e-mail address, and other similar contact information for a particular consumer.

Referring now to FIG. 21, this figure shows a method 2100 for selecting qualification forms according to a second exemplary embodiment of the present invention. Step 2103 is the first step in the process in which a command is received to enter a financial service provider side of a database 150. Next, in step 2106, options can be displayed that are accessible by financial service providers. Generally, step 2106 corresponds to displaying the options illustrated in the exemplary display screen 1300 of FIG. 13.

In decision step 2109, it is determined whether additional qualification forms are desired by a financial service provider. In other words, decision step 2109 generally corresponds to the shopping cart option 1305 that can be selected by a financial service provider in the exemplary display screen 1300 in FIG. 13. If the inquiry to decision step 2109 is negative, then the “no” branch is followed back to step 2106. If the inquiry to decision step 2109 is positive, then the “yes” branch is followed to step 2110 in which existing queries on the qualification forms are displayed. Step 2110 generally corresponds with exemplary display screen 1400 in which existing queries 1405 can be displayed.

Next, in decision step 2112, it is determined whether a financial service provider has selected an option of creating a new query. Generally, decision step 2112 can correspond to determining whether a financial service provider has selected the “Add LendingTree Query” button 1410 of the exemplary display screen 1400 of FIG. 14. If the inquiry to decision step 2112 is negative, then the “no” branch is followed to decision step 2121. If the inquiry to decision step 2112 is positive, then the “yes” branch is followed to step 2115 in which a new query is displayed.

Generally, step 2115 corresponds to the new query 1505 as illustrated in exemplary display screen 1500A of FIG. 15A. In step 2118, new query data can be received in the fields 1510 of the query 1505 in FIG. 15A. The process then proceeds to decision step 2127.

In decision step 2121, it is determined whether a financial service provider desires to edit an existing query. Generally, decision step 2121 corresponds with a financial service provider selecting the edit option 1415 of FIG. 14. If the inquiry to decision step 2121 is negative, then the “no” branch is followed back to decision step 2109. If the inquiry to decision step 2121 is positive, then the “yes” branch is followed to step 2124 in which an existing query is displayed and that can be edited by a financial service provider.

In decision step 2127, it is determined whether a financial service provider desires to customize query fields of a particular query. Generally, decision step 2127 corresponds with the customized option 1420 of exemplary display screen 1400 of FIG. 14. If the inquiry to decision step 2127 is negative, then the “no” branch is followed to decision step 2139. If the inquiry to decision step 2127 is positive, then the “yes” branch is followed to step 2130 in which customization options are displayed. Step 2130 generally corresponds with the exemplary display screen 1600A of FIG. 16.

Next, in step 2133, customization preferences can be received. In step 2136, the customization preferences can be stored and applied by the processor 112 of FIG. 2.

In decision step 2139, it is determined whether a financial service provider desires to execute a particular query. Decision step 2139 generally corresponds to the run query options 1407 of FIGS. 14 and 1507 of FIG. 15A. If the inquiry to decision step 2139 is positive, then the “yes” branch is followed to step 2148. If the inquiry to decision step 2139 is negative, then the “no” branch is followed to decision step 2142.

In decision step 2142, it is determined whether a query that has been created should be saved. Step 2142 generally corresponds to the save option illustrated in FIG. 15. If the inquiry to decision step 2142 is negative, then the “no” branch is followed back to decision step 2109. If the inquiry to decisions step 2142 is positive, then the “yes” branch is followed to step 2145 in which the query is store and then the process proceeds back to decision step 2109.

In step 2148, the query criteria that was set or selected by the financial service provider is applied to the qualification forms that exist in the database 150. The qualification forms in one exemplary embodiment, include those forms which did not receive a threshold number of offers from financial service providers.

For example, according to one exemplary embodiment, qualification forms that exist in the database 150 include those qualification forms which did not receive at least four offers from four different financial service providers. Those skilled in the art will recognize that the present invention is not limited to the threshold number of four and that fewer or greater number of offers are not beyond the scope and spirit of the present invention.

In step 2151, the qualification forms that match the query criteria that were selected by the financial service provider are identified. In decision step 2154, it is determined whether any of the qualification forms match the query criteria. If the inquiry to the decision step 2154 is negative, then the “no” branch is followed to step 2157 in which a no match message is displayed to the financial service provider. The process then returns to decision step 2142. If the inquiry to the decision step 2154 is negative, then the “no” branch is followed to step 2160, which means that matching qualification forms do not exist for the current query criteria.

In step 2160, a list of matching qualification forms are displayed. Step 2160 generally corresponds with the results Table 1705 that is illustrated in FIG. 17. Next, in decision step 2163, it is determined whether more information on a particular qualification form is desired by a financial service provider. Step 2163 generally corresponds to the hypertext link of qualification form identification number 1704 as illustrated in FIG. 17. If the inquiry to decision step 2163 is negative, then the “no” branch is followed to decision step 2169. If the inquiry to decision step 2163 is positive, then the “yes” branch is followed to step 2166 in which additional information for a selected qualification form is display. Step 2166 generally corresponds with the exemplary display screen 1800 of FIG. 18.

Next, in decision step 2169, it is determined whether a qualification form has been selected for purchase by a financial service provider. Decision step 2169 generally corresponds to the mark for purchase button illustrated in FIG. 18 as well as the purchase column 1702 as illustrated in FIG. 17. If the inquiry to decision step 2169 is negative, then the “no” branch is followed back to step 2160. If the inquiry to decision step 2169 is positive, then the “yes” branch is followed to step 2172 in which the qualification form is marked for purchase. Step 2172 generally corresponds to some sort of flag or marker where a particular qualification form can be indicated as marked for purchase in the database 150 as well as providing indication or indicator on a display screen so that a financial service provider will know that he or she selected a particular qualification form for purchase.

In decision step 2175, it is determined whether a financial service provider has decided to purchase selected qualification forms. In other words, decision step 2175 generally corresponds to the purchase qualification forms button 1732 as illustrated in FIG. 17. If the inquiry to decision step 2175 is negative, then the “no” branch is followed to decision step 2184. If the inquiry to decision step 2175 is positive, then the “yes” branch is followed to step 2178 in which the qualification forms selected by the financial service provider for purchase are displayed. Step 2178 generally corresponds to the exemplary display screen 1900 of FIG. 19. Next, in step 2181, the process continues to step 2187 of FIG. 21B.

In decision step 2184, it is determined whether a financial service provider desires to return to the query list as illustrated in FIG. 14. If the inquiry to decision step 2184 is negative, then the “no” branch is followed back to step 2160. If the inquiry to decision step 2184 is positive, then the “yes” branch is followed to step 2124 in which existing queries are displayed to the financial service provider.

Referring now to FIG. 21B, this figure shows a remainder of steps continuing from the method 2100 for selecting qualification forms as illustrated in FIG. 21A. In step 2187, the process has continued from step 2184 of FIG. 21A. In decision step 2190, it is determined whether a financial service provider has confirmed his purchase of selected qualification forms. Decision step 2190 generally corresponds to the confirm purchase button 1905 of FIG. 19. If the inquiry to decision step 2190 is negative, then the “no” branch is followed to step 2192 in which the process returns to step 2160 of FIG. 21A where a list of matching qualification forms are displayed to the financial service provider.

If the inquiry to decision step 2190 is positive, then the “yes” branch is followed to step 2193 in which the qualification forms in the database 150 are marked as purchased so that each qualification form is sold to a select number of financial service providers. According to one exemplary aspect of the present invention, the select number of financial service providers is one. For this instance where the select number is one, this means that only one financial service provider is given a particular qualification form as a result of purchase. However, those skilled in the art recognize that in some instances, qualification forms offered to more than one financial service provider, may still be commercially viable for those financial service providers who desire leads on particular consumers. The present invention is not limited to the number of financial service providers who are permitted access to a particular qualification form.

In step 2194, the purchased qualification forums can be sent to the financial service provider. The qualification forms that are sent will include all information contained in the form. That is, these qualification forms will be complete records that can include full contact information on the consumer. The full contact information can include, but is not limited to, name, mailing address, telephone number, e-mail address, fax number, and other like contact information for conducting business with a consumer.

In step 2194, a variety of methods for sending the qualification forms can be used without departing from the scope and spirit of the present invention. The qualification forms could be sent to the financial service provider in a file attachment to an e-mail message. Alternatively, the qualification forms could be made available for download by the financial service provider where the provider could select the file format for the download. Also, hard copies of the qualification forms could be mailed or faxed to the financial service provider. Those skilled in the art will appreciate that a variety of methods for sending the purchased qualification forms to the financial service provider could be used without deviating from the scope and spirit of the present invention.

Next, in decision step 2196, it is determined whether a financial service provider is finished searching for additional qualification forms. If the inquiry to decision step 2196 is negative, then the “no” branch is followed to step 2198 in which the process returns to step 2124 of FIG. 21A in which an existing set of queries can be display to the financial service provider. If the inquiry to decision step 2196 is positive, then the “yes” branch is followed to step 2199 in which the process ends.

While several embodiments of the present invention have been shown and described, it is to be understood that many changes and modifications may be made thereunto without departing from the spirit and scope of the invention as defined in the appended claims.

What is claimed is:

1. A method for selecting a qualification form from a group of qualification forms that address at least one of a financial service and product, comprising:
filtering qualification forms automatically with first selection criteria; and
filtering qualification forms remaining after automatic filtering with second selection criteria.

2. The method of claim 1, wherein filtering qualification forms automatically further comprises filtering in response to receiving a qualification form transmitted electronically by a consumer.

3. The method of claim 1, wherein filtering qualification forms remaining after automatic filtering with second selection criteria further comprises receiving the second selection criteria from a financial service provider.

4. The method of claim 1, wherein filtering qualification forms automatically further comprises tracking those qualification forms that did not receiving a threshold number of offers from one or more financial service providers.

5. The method of claim 1, further comprising employing first selection criteria that is different from the second selection criteria.

6. The method of claim 1, further comprising employing first selection criteria that is more conservative than the second selection criteria.

7. The method of claim 1, further comprising selecting qualification forms individually from a group of qualification forms.

8. The method of claim 1, wherein the at least one of a financial service and product comprises one of a small business loan, a commercial mortgage, a first mortgage, a second mortgage, a car loan, a student loan, a personal loan, a credit card, a bank account, a stock brokerage account, and a retirement account.

9. A method for selecting qualification forms for providing one of a financial service and product, comprising:
receiving selection criteria comprising parameters pertaining to information fields contained within qualification forums stored in a database;
filtering the qualification forums with the selection criteria;
displaying a list of qualification forms matching the selection criteria and organized based in accordance with the selection criteria; and
receiving a selection of one or more individual qualification forms that are displayed.

10. The method of claim 9, further comprising receiving data for customizing the selection criteria.

11. The method of claim 9, receiving a request for purchasing the selection of one or more qualification forms.

12. The method of claim 9, further comprising identifying a qualification forum as purchased in a database containing a plurality of qualification forums.

13. The method of claim 9, further comprising restricting access to a qualification forum that has been purchased by a financial service provider.

14. The method of claim 9, further comprising restricting access to a qualification forum such that only one financial service provider can purchase a qualification forum.

15. The method of claim 9, wherein the at least one of a financial service and product comprises one of a small business loan, a commercial mortgage, a first mortgage, a second mortgage, a car loan, a student loan, a personal loan, a credit card, a bank account, a stock brokerage account, and a retirement account.

16. A method for selling qualification forms over a computer network comprising:
receiving parameters for customizing a search on a plurality of qualification forms stored in a database;
conducting the search on the plurality of qualification forms stored in the database based on the received parameters;
organizing qualification forms matching the parameters based on the parameters; displaying the qualification forms matching the customized search; and
receiving data for marking one or more qualification forums for purchase.

17. The method of claim 16, wherein displaying the qualification forums matching the customized search further comprises displaying a portion of information contained in the qualification form.

18. The method of claim 16, further comprising:
confirming a purchase of one or more qualification forums; and
making all information contained in the one or more qualification forums available after confirmation of purchase.

19. The method of claim 16, further comprising:
confirming a purchase of one or more qualification forums; and
making contact information contained in the one or more qualification forums available after confirmation of purchase.

20. The method of claim 1, wherein the qualification forums contain data pertaining to one of a financial service and financial product, the financial service and product comprising at least one of a small business loan, a commercial mortgage, a first mortgage, a second mortgage, a car loan, a student loan, a personal loan, a credit card, a bank account, a stock brokerage account, and a retirement account.

21. A method for identifying a financial service provider for a business transaction, comprising:
receiving selection criteria from a financial service provider;
receiving qualification form data from one of a qualification form applicant and financial service provider; and
automatically applying the selection criteria to determine if the qualification form data falls within the selection criteria.

22. The method of claim 21, wherein receiving qualification form data from one of the qualification form applicant and financial service provider further comprises receiving a credit score about the qualification form applicant from a credit agency.

23. The method of claim 22, wherein receiving a credit score about the qualification form applicant from the credit agency further comprises receiving a Fair Isaac Credit Score concerning the qualification form applicant.

24. The method of claim 21, wherein receiving qualification form data from one of the qualification form applicant and the financial service provider further comprises receiving a field of information that is part of a qualification form.

25. The method of claim 24, wherein receiving the field of information that is part of the qualification form further comprises receiving at least one of a social security number, address, phone number, e-mail address, state of residence, and income of the qualification form applicant.
